(19) United States
(12) Patent Application Publication
(10) Pub. No.: US 2014/0063868 A1
(43) Pub. Date: Mar. 6, 2014

(54) POWER SUPPLY APPARATUS WITH POWER FACTOR CORRECTION AND PULSE WIDTH MODULATION MECHANISM AND METHOD THEREOF

(71) Applicant: FSP TECHNOLOGY INC., Taoyuan County (TW)

(72) Inventors: Yung-Hsiang Shih, Taoyuan County (TW); Chang-Hsun Chiang, Taoyuan County (TW)

(73) Assignee: FSP TECHNOLOGY INC., Taoyuan County (TW)

(21) Appl. No.: 14/019,551

(22) Filed: Sep. 6, 2013

(30) Foreign Application Priority Data
Sep. 6, 2012 (TW) 101132538

(51) Int. Cl. G05F 1/563; H02M 1/42; H02M 3/335

(52) U.S. Cl. CPC G05F 1/563; H02M 3/33507; H02M 1/4208
USPC 363/21.18

(57) ABSTRACT

A power supply apparatus that includes a pulse width modulation (PWM) based power conversion unit and a power factor correction (PFC) conversion unit is provided. The PWM-based power conversion unit is configured to receive a direct current (DC) input voltage and perform pulse width modulation on the received DC input voltage in response to a power supply request of a load, so as to generate a DC output voltage to the load. The PFC conversion unit is coupled to the PWM-based power conversion unit and configured to perform power factor correction on a rectification voltage associated with an alternating current (AC) input voltage, so as to generate the DC input voltage. The PFC conversion unit is further configured to adjust the generated DC input voltage in response to a variation of the load.

### CROSS-REFERENCE TO RELATED APPLICATION

This application claims the priority benefit of Taiwan application serial no. 101132538, filed on Sep. 6, 2012. The entirety of the above-mentioned patent application is hereby incorporated by reference herein and made a part of this specification.

### BACKGROUND OF THE INVENTION

1. Field of the Invention

The invention relates to a power supply technique; more particularly, the invention relates to a power supply apparatus with a power factor correction (PFC) mechanism and a pulse width modulation (PWM) mechanism and a power supply method.

2. Description of Related Art

A power supply apparatus mainly serves to convert alternating current (AC) input power provided by an electric utility into direct current (DC) output power suitable for a variety of electronic devices. The AC input power is characterized by high voltage and low stability, while the DC output power is characterized by low voltage and favorable stability. The power supply apparatus is extensively applied to electronic devices, such as computers, office automation accessories, industrial control equipment, communication devices, and so forth.

Most of the existing power supply apparatuses are equipped with front-end stage power factor correction (PFC) conversion units, so as to provide fixed DC input voltages to back-end stage power conversion units. Here, the fixed DC input voltage reaches 380V. Besides, no matter whether the power supply apparatus is in a light-load state or in a heavy-load state, the PFC conversion unit provides the fixed high voltage (at 380V) to the back-end stage power conversion unit. Therefore, subject to the condition of constant power, power loss of the power supply apparatus in the light-load state (as compared to the heavy-load state) may increase, thus deteriorating the overall efficiency of the power supply apparatus.

### SUMMARY OF THE INVENTION

The invention is directed to a power supply apparatus with a PFC mechanism and a PWM mechanism and a power supply method capable of resolving the issues mentioned above.

An exemplary embodiment of the invention provides a power supply apparatus that includes a PWM-based power conversion unit and a PFC conversion unit. The PWM-based power conversion unit is configured to receive a DC input voltage and perform pulse width modulation on the received DC input voltage in response to a power supply request of a load, so as to generate a DC output voltage to the load. The PFC conversion unit is coupled to the PWM-based power conversion unit and configured to perform power factor correction on a rectification voltage associated with an AC input voltage, so as to generate the DC input voltage. The PFC conversion unit is further configured to adjust the generated DC input voltage in response to a variation of the load.

In an exemplary embodiment of the invention, the PWM-based power conversion unit includes a transformer, a power switch, a resistor, a power converter, and a PWM controller. The transformer has a primary side and a secondary side. A first terminal of the primary side of the transformer is configured to receive the DC input voltage, and the secondary side of the transformer is configured to provide an AC induction voltage. A first terminal of the power switch is coupled to a second terminal of the primary side of the transformer, a second terminal of the power switch is coupled to a node, and a control terminal of the power switch is configured to receive a PWM signal. A first terminal of the resistor is coupled to the node, and a second terminal of the resistor is coupled to a ground potential. The power converter coupled to the secondary side of the transformer and configured to convert the AC induction voltage, so as to obtain the DC output voltage and provide the DC output voltage to the load. The PWM controller is coupled to the control terminal of the power switch and configured to generate the PWM signal in response to the power supply request of the load and adjust the PWM signal in response to the variation of the load.

In an exemplary embodiment of the invention, the PWM-based power conversion unit further includes a feedback unit that is coupled to the power converter and the PWM controller and configured to provide a feedback signal associated with the DC output voltage to the PWM controller, such that the PWM controller is aware of the variation of the load.

In an exemplary embodiment of the invention, a voltage of the node is changed together with the adjustment of the PWM signal, so as to reflect the variation of the load. On this condition, the PFC conversion unit adjusts the DC input voltage according to the voltage of the node. The PWM controller is further configured to determine whether to activate an over current protection mechanism or not according to the voltage of the node and a built-in over current protection reference voltage, so as to protect the power supply apparatus.

In an exemplary embodiment of the invention, when the PWM controller determines that the voltage of the node is greater than the built-in over current protection reference voltage, the PWM controller activates the over current protection mechanism, so as to stop generating the PWM signal.

In an exemplary embodiment of the invention, when the PWM controller increases a duty cycle of the PWM signal in response to the variation of the load, the voltage of the node correspondingly increases, and the PFC conversion unit accordingly increases the DC input voltage. By contrast, when the PWM controller decreases a duty cycle of the PWM signal in response to the variation of the load, the voltage of the node correspondingly decreases, and the PFC conversion unit accordingly decreases the DC input voltage.

Another exemplary embodiment of the invention provides a power supply method that includes steps of: performing power factor correction on a rectification voltage associated with an AC input voltage, so as to generate a DC input voltage; performing pulse width modulation on the DC input voltage by a means of PWM-based power conversion, so as to generate a DC output voltage to a load; adjusting the DC input voltage and the DC output voltage according to a variation of the load.

In an exemplary embodiment of the invention, the DC input voltage generated after the power factor correction increases together with an increase in the load and decreases together with a decrease in the load.

As is discussed above, in the power supply apparatus and the power supply method, the output of the front-end stage PFC conversion unit and the output of the back-end stage PWM-based power conversion unit are adjusted in response to the variation of the load (e.g., light, middle, or heavy load). That is, the output of the front-end stage PFC conversion unit is no longer a fixed high voltage and will be changed together with the variation of the load (i.e., the output of the front-end stage PFC conversion unit increases together with the increase in the load or decreases together with the decrease in the load). Thereby, subject to the condition of constant power, power loss of the power supply apparatus in the light-load state (as compared to the heavy-load state) may be significantly reduced as expected, thus ameliorating the overall efficiency of the power supply apparatus.

However, the above descriptions and the below embodiments are only used for explanation, and they do not limit the scope of the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a power supply apparatus 10 according to an exemplary embodiment of the invention.

FIG. 2 is a schematic diagram of the PWM-based power conversion unit depicted in FIG. 1.

FIG. 3 is a flow chart illustrating a power supply method according to an exemplary embodiment of the invention.

### DETAILED DESCRIPTION OF DISCLOSED EMBODIMENTS

Descriptions of the invention are given with reference to the exemplary embodiments illustrated with accompanied drawings, wherein same or similar parts are denoted with same reference numerals. In addition, whenever possible, identical or similar reference numbers stand for identical or similar elements in the figures and the embodiments.

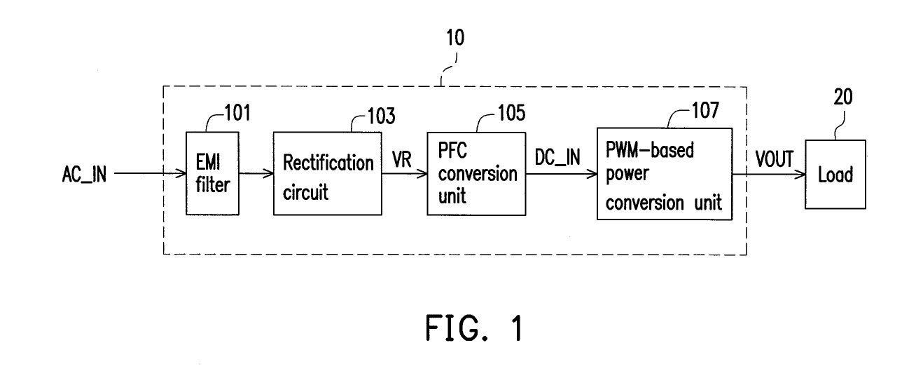

FIG. 1 is a schematic diagram of a power supply apparatus 10 according to an exemplary embodiment of the invention. With reference to FIG. 1, the power supply apparatus 10 includes an electromagnetic interference (EMI) filter 101, a rectification circuit 103, a PFC (Power Factor Correction) conversion unit 105, and a PWM-based (Pulse-Width-Modulation-based) power conversion unit 107.

In the present exemplary embodiment, the EMI filter 101 is coupled between an AC input voltage AC_IN and the rectification circuit 103 and configured to suppress electromagnetic noise of the AC input voltage AC_IN. Here, the AC input voltage AC_IN includes but is not limited to commercial/city power. The rectification circuit 103 is configured to receive the AC input voltage AC_IN from the EMI filter 101 and rectify the AC input voltage AC_IN, so as to generate a rectification voltage VR.

The PFC conversion unit 105 is coupled to the rectification circuit 103 and configured to perform power factor correction on the rectification voltage VR associated with the AC input voltage AC_IN, so as to generate a DC input voltage DC_IN. The PWM-based power conversion unit 107 is coupled to the PFC conversion unit 105 and configured to receive the DC input voltage DC_IN from the PFC conversion unit 105 and perform pulse width modulation on the received DC input voltage DC_IN in response to a power supply request of a load 20, so as to generate a DC output voltage VOUT to the load 20.

In the present exemplary embodiment, the PFC conversion unit 105 adjusts the DC input voltage DC_IN generated by itself in response to the variation of the load 20 (e.g., light, middle, or heavy load). That is, the DC input voltage DC_IN generated by the PFC conversion unit 105 is changed together with the variation of the load 20 (e.g., light, middle, or heavy load) and is no longer a constantly high voltage.

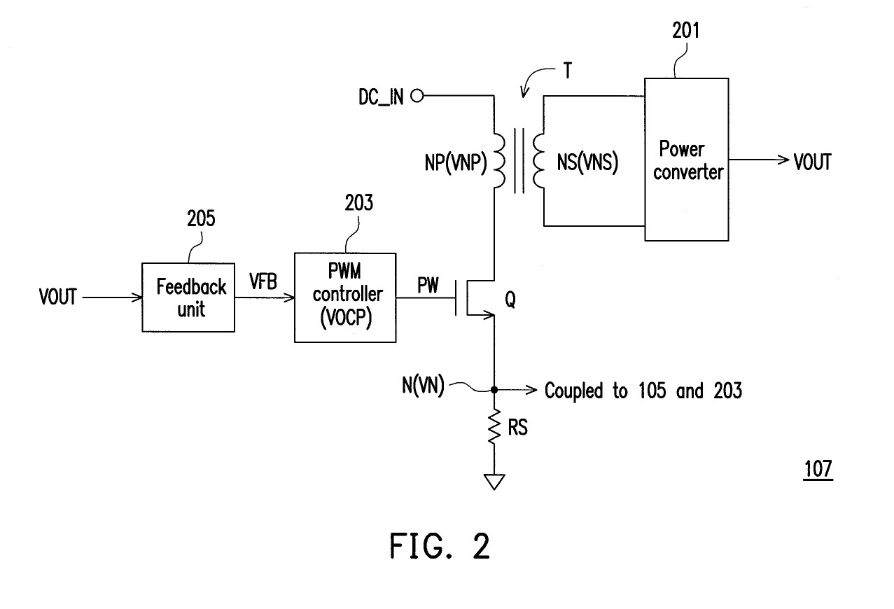

Specifically, FIG. 2 is a schematic diagram of the PWM-based power conversion unit depicted in FIG. 1. With reference to FIG. 1 and FIG. 2, the PWM-based power conversion unit 107 includes a transformer T, a power switch Q, a resistor RS, a power converter 201, a PWM controller 203, and a feedback unit 205.

The transformer T has a primary side NP and a secondary side NS. A first terminal of the primary side NP of the transformer T is configured to receive the DC input voltage DC_IN from the PFC conversion unit 105, and the secondary side NS of the transformer T is configured to provide an AC induction voltage VNS. Here, the AC induction voltage VNS may be determined by the AC voltage VNP at the primary side NP and a turn ratio (NP/NS) of the primary side NP to the secondary side NS.

A first terminal of the power switch Q is coupled to a second terminal of the primary side NP of the transformer T, a second terminal of the power switch Q is coupled to a node N, and a control terminal of the power switch Q is configured to receive a PWM signal PW from the PWM controller 203. In the present exemplary embodiment, the power switch Q may be implemented by an N-type power transistor, which should however not be construed as a limitation to the invention.

A first terminal of the resistor RS is coupled to the node N, and a second terminal of the resistor RS is coupled to a ground potential. The power converter 201 is coupled to the secondary side NS of the transformer T, so as to convert the AC induction voltage VNS at the secondary side NS of the transformer T (i.e., the AC-to-DC conversion) and supply the DC output voltage VOUT to the load 20. In the present exemplary embodiment, the power converter 201 may be a forward power converter or a flyback power converter, which should however not be construed as a limitation to the invention. Any other topology of power converter may fall within the scope of the invention.

The PWM controller 203 is coupled to the control terminal of the power switch Q and configured to generate the PWM signal PW in response to the power supply request of the load 20, so as to turn on or turn off the power switch Q. Besides, the PWM controller 203 may also adjust the PWM signal PW by modifying/changing a duty cycle (i.e., a working cycle) of the PWM signal PW in response to the variation of the load 20 (i.e., light, middle, or heavy load).

The feedback unit 205 is coupled to the power converter 201 and the PWM controller 203 and configured to provide a feedback signal VFB associated with the DC output voltage VOUT to the PWM controller 203, such that the PWM controller 20 is aware of the variation of the load 20. In the present exemplary embodiment, the feedback unit 205 may be constituted by a simple voltage divider circuit; alternatively, a photocoupler may be applied to output the feedback associated with the AC output voltage VOUT. However, the invention is not limited thereto.

In light of the foregoing, the PWM controller 203 adjusts the PWM signal PW in response to the variation of the load 20; therefore, the voltage VN of the node N between the power switch Q and the resistor RS is changed in response to the adjustment of the PWM signal PW, so as to reflect the variation of the load 20. This is because the current flowing through the primary side NP of the transformer T may vary. Thereby, the PFC conversion unit 105 is able to adjust the DC input voltage DC_IN generated by itself according to the voltage VN of the node N. In other words, the DC input voltage DC_IN generated by the PFC conversion unit 105 is changed in response to (or with) the variation of the load 20.

The PWM controller 203 may also determine whether to activate an over current protection (OCP) mechanism or not according to the voltage VN of the node N, so as to protect the power supply apparatus 10. In the present exemplary embodiment, the PWM controller 203 has a built-in OCP reference voltage VOCP. As long as the PWM controller 203 determines that the voltage VN of the node N is greater than the built-in OCP reference voltage VOCP, the PWM controller 203 activates the OCP mechanism, so as to stop generating the PWM signal PW and protect the power supply apparatus 10 from being damaged by the over current.

On the other hand, the PWM controller 203 is able to learn/obtain the variation of the load 20 through the feedback unit 205; therefore, when the PWM controller 203 increases the duty cycle of the PWM signal PW in response to the variation of the load 20 (e.g., the heavy load), the voltage VN of the node N also increases. On this condition, the PFC conversion unit 105 correspondingly increases the DC input voltage DC_IN generated by itself. On the contrary, when the PWM controller 203 decreases the duty cycle of the PWM signal PW in response to the variation of the load 20 (e.g., the light load), the voltage VN of the node N also decreases. On this condition, the PFC conversion unit 105 correspondingly decreases the DC input voltage DC_IN generated by itself.

Therefore, the output (DC_IN) of the front-end stage PFC conversion unit 105 and the output (VOUT) of the back-end stage PWM-based power conversion unit 107 are adjusted in response to the variation of the load 20 (e.g., light, middle, or heavy load). Apparently, the output (DC_IN) of the front-end stage PFC conversion unit 105 is no longer a fixed high voltage and will be changed together with the variation of the load 20 (i.e., the output of the front-end stage PFC conversion unit 105 increases together with the increase in the load 20 or decreases together with the decrease in the load 20). Thereby, subject to the condition of constant power, power loss of the power supply apparatus 10 in the light-load state (as compared to the heavy-load state) may be significantly reduced as expected, thus ameliorating the overall efficiency of the power supply apparatus 10.

Although the voltage VN of the node N between the power switch Q and the resistor RS reflects the variation of the load 20 and thereby adjusts the output (DC_IN) of the PFC conversion unit 105 according to the previous embodiments, it should be mentioned that the invention is not limited thereto. That is, in the PWM-based power conversion unit 107, any node that may reflect the variation of the load 20 may replace the node N between the power switch Q and the resistor RS according to the actual design requirements.

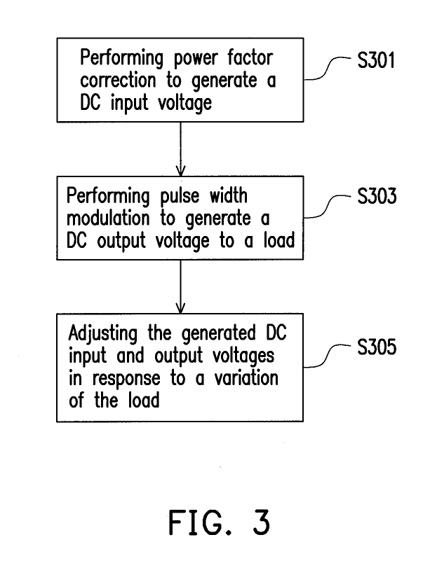

Based on the disclosure of the aforesaid embodiments, FIG. 3 shows a flow chart of a power supply method according to an embodiment of the invention. With reference to FIG. 3, the power supply method described in the present exemplary embodiment may include following steps.

In step S301, power factor correction is performed on a rectification voltage associated with an AC input voltage, so as to generate a DC input voltage. Here, the AC input voltage includes but is not limited to commercial/city power.

In step S303, pulse width modulation is performed on the DC input voltage by a means of PWM-based power conversion, so as to generate a DC output voltage to a load. Here, the load includes but is not limited to an electronic device.

In step S305, the generated DC input voltage and the generated DC output voltage are adjusted according to a variation of the load (e.g., light, middle, or heavy load).

In the present exemplary embodiment of the invention, the DC input voltage generated after the power factor correction increases together with an increase in the load (e.g., heavy load) and decreases together with a decrease in the load (e.g., light load). In other words, the DC input voltage generated after power factor correction is changed in response to the variation of the load.

To sum up, in the power supply apparatus and the power supply method, the output of the front-end stage PFC conversion unit and the output of the back-end stage PWM-based power conversion unit are adjusted in response to the variation of the load (e.g., light, middle, or heavy load). That is, the output of the front-end stage PFC conversion unit is no longer a fixed high voltage and will be changed together with the variation of the load (i.e., the output of the front-end stage PFC conversion unit increases together with the increase in the load or decreases together with the decrease in the load). Thereby, subject to the condition of constant power, power loss of the power supply apparatus in the light-load state (as compared to the heavy-load state) may be significantly reduced as expected, thus ameliorating the overall efficiency of the power supply apparatus.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents. Any of the embodiments or any of the claims of the invention does not need to achieve all of the advantages or features disclosed by the invention. Moreover, the abstract and the headings are merely used to aid in searches of patent files and are not intended to limit the scope of the claims of the present invention.

What is claimed is:

1. A power supply apparatus comprising:
a pulse-width-modulation-based power conversion unit configured to receive a direct current input voltage and perform pulse width modulation on the received direct current input voltage in response to a power supply request of a load, so as to generate a direct current output voltage to the load; and
a power factor correction conversion unit coupled to the pulse-width-modulation-based power conversion unit and configured to perform power factor correction on a rectification voltage associated with an alternating current input voltage, so as to generate the direct current input voltage,
wherein the power factor correction conversion unit is further configured to adjust the generated direct current input voltage in response to a variation of the load.

2. The power supply apparatus as recited in claim 1, wherein the pulse-width-modulation-based power conversion unit comprises:
a transformer having a primary side and a secondary side, wherein a first terminal of the primary side is configured to receive the direct current input voltage, and the secondary side is configured to provide an alternating current induction voltage;
a power switch having a first terminal coupled to a second terminal of the primary side, a second terminal coupled to a node, and a control terminal configured to receive a pulse width modulation signal;
a resistor having a first terminal coupled to the node and a second terminal coupled to a ground potential;
a power converter coupled to the secondary side and configured to convert the alternating current induction voltage, so as to obtain the direct current output voltage and provide the direct current output voltage to the load; and
a pulse width modulation controller coupled to the control terminal of the power switch, wherein the pulse width modulation controller is configured to generate the pulse width modulation signal in response to the power supply request and adjust the pulse width modulation signal in response to the variation of the load.

3. The power supply apparatus as recited in claim 2, wherein the pulse-width-modulation-based power conversion unit further comprises:
a feedback unit coupled to the power converter and the pulse width modulation controller and configured to provide a feedback signal associated with the direct current output voltage to the pulse width modulation controller, such that the pulse width modulation controller is aware of the variation of the load.

4. The power supply apparatus as recited in claim 2, wherein a voltage of the node is changed together with the adjustment of the pulse width modulation signal, so as to reflect the variation of the load.

5. The power supply apparatus as recited in claim 4, wherein the power factor correction conversion unit adjusts the direct current input voltage according to the voltage of the node.

6. The power supply apparatus as recited in claim 5, wherein when the pulse width modulation controller increases a duty cycle of the pulse width modulation signal in response to the variation of the load, the voltage of the node correspondingly increases, and the power factor correction conversion unit accordingly increases the direct current input voltage.

7. The power supply apparatus as recited in claim 5, wherein when the pulse width modulation controller decreases a duty cycle of the pulse width modulation signal in response to the variation of the load, the voltage of the node correspondingly decreases, and the power factor correction conversion unit accordingly decreases the direct current input voltage.

8. The power supply apparatus as recited in claim 4, wherein the pulse width modulation controller is further configured to determine whether to activate an over current protection mechanism or not according to the voltage of the node and a built-in over current protection reference voltage, so as to protect the power supply apparatus.

9. The power supply apparatus as recited in claim 8, wherein when the pulse width modulation controller determines that the voltage of the node is greater than the built-in over current protection reference voltage, the pulse width modulation controller activates the over current protection mechanism, so as to stop generating the pulse width modulation signal.

10. The power supply apparatus as recited in claim 2, wherein the power converter comprises a forward power converter or a flyback power converter.

11. The power supply apparatus as recited in claim 2, wherein the power switch is implemented by an N-type power transistor.

12. The power supply apparatus as recited in claim 1, further comprising:
a rectification circuit configured to receive and rectify the alternating current input voltage, so as to generate the rectification voltage.

13. The power supply apparatus as recited in claim 12, further comprising:
an electromagnetic interference filter coupled between the alternating current input voltage and the rectification circuit and configured to suppress electromagnetic noise of the alternating current input voltage.

14. A power supply method comprising:
performing power factor correction on a rectification voltage associated with an alternating current input voltage, so as to generate a direct current input voltage;
performing pulse width modulation on the direct current input voltage by a means of pulse-width-modulation-based power conversion, so as to generate a direct current output voltage to a load; and
adjusting the direct current input voltage and the direct current output voltage according to a variation of the load.

15. The power supply method as recited in claim 14, wherein the direct current input voltage generated after the power factor correction increases together with an increase in the load and decreases together with a decrease in the load.
